(19) United States
(12) Patent Application Publication
(10) Pub. No.: US 2013/0120361 A1
(43) Pub. Date: May 16, 2013

(54) SPATIAL 3D INTERACTIVE INSTRUMENT

(71) Applicants: Hau-Wei Wang, New Taipei City (TW); Fu-Cheng Yang, Xinpu Township (TW); Shu-Ping Dong, Taiping City (TW); Tsung-Han Li, New Taipei City (TW)

(72) Inventors: Hau-Wei Wang, New Taipei City (TW); Fu-Cheng Yang, Xinpu Township (TW); Shu-Ping Dong, Taiping City (TW); Tsung-Han Li, New Taipei City (TW)

(73) Assignee: Industrial Technology Research Institute, Chutung (TW)

(21) Appl. No.: 13/297,591

(22) Filed: Nov. 16, 2011

(51) Int. Cl. G06F 3/038; G06T 15/00; G01B 11/14

(52) U.S. Cl. 345/419; 356/623

(57) ABSTRACT

Systems and methods for determining three-dimensional (3D) absolute coordinates of objects are disclosed. The system may include at least one light source providing illumination, a path altering unit to manipulate the path of the light from the light source, a plurality of sensors to sense the light reflected and diffused from objects, and a controller to determine the three-dimensional absolute coordinates of the objects based in part on the reflected light detected by the sensors.

### FIELD

The present disclosure relates to systems and methods for three-dimensional (3D) sensing technology. In particular, the disclosure relates to systems and methods for determining objects' three-dimensional (3D) absolute coordinates for enhanced human-machine interaction.

### BACKGROUND

Machine-human interfaces encompass a variety of technologies including capacitive, resistive, and infrared, and are widely used in different applications. In devices such as cell phones and personal computing systems, these interfaces aid users in communicating with the devices via touchscreen or other sensing mechanisms. Motion sensing and object tracking have also become popular, especially for entertainment, gaming, educational, and training applications. For example, sales of Microsoft's Kinect®, a gaming console having motion-sensing functionalities, have topped more than 10 million units since its release in late 2010.

However, some of the designs or applications of traditional tracking technologies such as time-of-flight (TOF), laser tracking, and stereo vision, may lack the ability to provide certain information concerning the detected object or environment. For example, many do not provide an object's three-dimensional (3D) absolute coordinates in space.

It may therefore be desirable to have systems, methods, or both that may determine the three-dimensional (3D) absolute coordinates of objects under analysis. The application may include object-sensing, motion-sensing, scanning and recreating of a three-dimensional (3D) image. Further, with the introduction of affordable three-dimensional (3D) displays, it may be desirable to have systems and methods that may determine the three-dimensional (3D) absolute coordinates for various applications, such as human-machine interaction, surveillance, etc.

### SUMMARY

The disclosed embodiments may include systems, display devices, and methods for determining three-dimensional coordinates.

The disclosed embodiments include a non-contact coordinate sensing system for identifying three-dimensional coordinates of an object. The system may include a light source configured to illuminate light to the object and to be controlled for object detection, a first detecting device configured to detect light reflected from the object to a first location, the first location being identified by a first set of three-dimensional coordinates, a second detecting device configured to detect light reflected from the object to a second location, the second location being identified by a second set of a three-dimensional coordinates, a third detecting device configured to detect light reflected from the object to a third location, the third location being identified by a third set of a three-dimensional coordinates, and a control circuit coupled to the at least one light source and the first, second, and third detecting devices. The control circuit may be configured to determine the three-dimensional coordinates of the object at least based on the phase differences between the reflected light detected at one of the first, second, and third locations and the reflected light detected at remaining locations.

The disclosed embodiments further include an interactive three-dimensional (3D) display system including at least one light source for illuminating light to an object and to be controlled for object detection, a first light detecting device for detecting reflected light from the object to a first location, the first location being identified by a first set of three-dimensional coordinates, a second light detecting device for detecting reflected light from the object to a second location, the second location being identified by a second set of three-dimensional coordinates, a third light detecting device for detecting reflected light from the object to a second location, the second location being identified by a third set of three-dimensional coordinates, and a control circuit coupled the at least one light source and the first, second, and third light detecting devices. The control circuit may be configured to determine three dimensional coordinates of the object. The control circuit may also be configured to produce 3D images with three-dimensional coordinates and to determine an interaction between the object and the 3D images based on the three-dimensional coordinates of the object and the three-dimensional coordinates of the 3D images.

The disclosed embodiments further include a method of identifying three-dimensional (3D) coordinates of an object. The method may include illuminating light to the object, sensing light reflected by the object by at least three sensing devices at different locations identified by a different set of three-dimensional coordinates. The method may also include calculating, by a processor, the three-dimensional coordinates of the object based on the phase differences between the reflected light detected at one of the locations and the reflected light detected at the remaining locations.

It is to be understood that both the foregoing general description and the following detailed description are exemplary only and are not restrictive of the claimed subject matter.

The accompanying drawings, which are incorporated in and constitute a part of this specification, illustrate various disclosed embodiments and, together with the description, serve to explain the various embodiments.

### BRIEF DESCRIPTION OF THE DRAWINGS

The accompanying drawings, which are incorporated in and constitute a part of this specification, illustrate disclosed embodiments described below.

FIG. 1 illustrates an exemplary schematic diagram of an exemplary three-dimensional (3D) absolute coordinate sensing system consistent with some of the disclosed embodiments.

FIG. 2 illustrates an exemplary flow diagram of an exemplary method for determining three-dimensional (3D) absolute coordinates of objects under analysis consistent with some of the disclosed embodiments.

FIG. 3 illustrates an exemplary embodiment of a three-dimensional (3D) absolute coordinate sensing system including placement of certain components consistent with some of the disclosed embodiments.

FIG. 4 illustrates an exemplary embodiment of incident and reflected/diffused light-waves corresponding to individual sensors consistent with some of the disclosed embodiments.

FIG. 5 illustrates an exemplary embodiment of an object's three-dimensional (3D) absolute coordinates in relation to the coordinates of various individual sensors consistent with some of the disclosed embodiments.

FIGS. 6A and 6B illustrate an exemplary embodiment of an interactive three-dimensional (3D) absolute coordinate sensing system including coordinates of a perceived image consistent with some of the disclosed embodiments.

### DESCRIPTION OF THE EMBODIMENTS

Reference will now be made in detail to the exemplary embodiments, examples of which are illustrated in the accompanying drawings. Wherever possible, the same reference numbers will be used throughout the drawings to refer to the same or like parts.

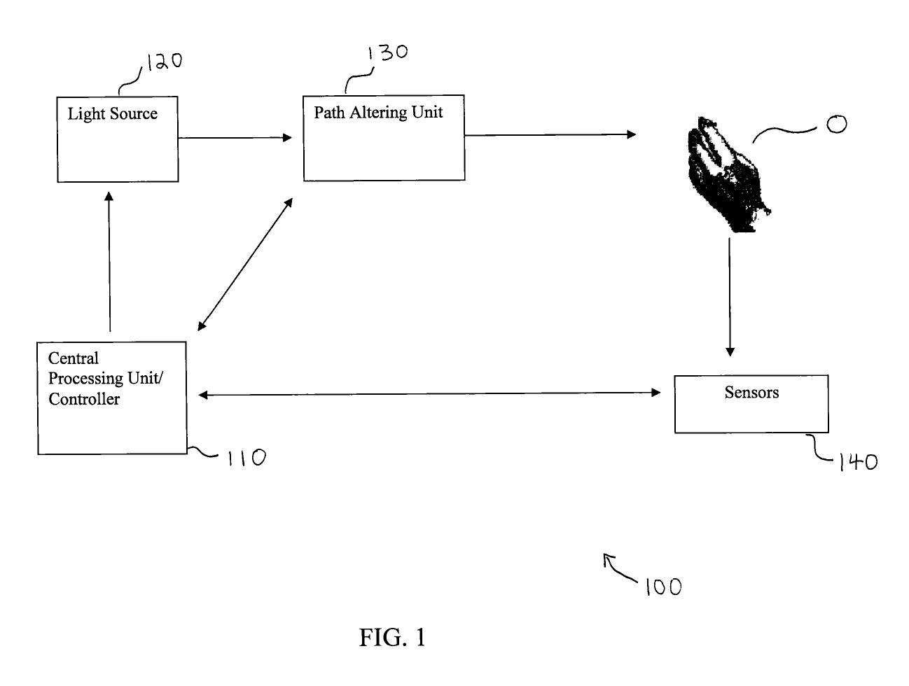

FIG. 1 depicts an exemplary three-dimensional (3D) absolute coordinate sensing system 100. Consistent with some embodiments, sensing system 100 may be a personal computing device, an entertainment/gaming system or console, a cellular device, a smart phone, etc.

In sensing system 100, a central processing unit/controller 110 controls a light source 120 to illuminate light. In one exemplary embodiment, the light source 120 is made of a laser diode generating light in the MHz range which may be adjusted by the central processing unit 110. The light from light source 120 is directed to a path altering unit 130 which changes the path of the light. The path altering unit 130 is composed of at least one MEMS mirror. The path altering unit 130 may also be other devices that may reflect light and/or may be controlled. In one embodiment, the processor 110 may continuously and automatically adjust the path altering unit 130 based on desired specifications appropriate for the various applications. When the redirected light from the path altering unit 130 shines on an object O, such as a hand or a fingertip, light reflected from object O is captured by sensing unit 140. In other embodiments, the light source 120 is directly illuminated on the object O and a path altering unit 130 is not required.

Sensing unit 140 includes three or more light detectors or sensors, and each may be controlled by the processor 110. Information from the sensing unit 140, including detectors positions and phase difference among the detectors, may be provided or made available to the central processing unit 110. The exemplary calculations performed by central processing unit 110 will be described in detail below. In alternative embodiments, the light source 120 may include one or more illumination elements, which may be operating at different frequencies and may be used in conjunction with the sensing unit 140, or with a plurality of sensing units 140.

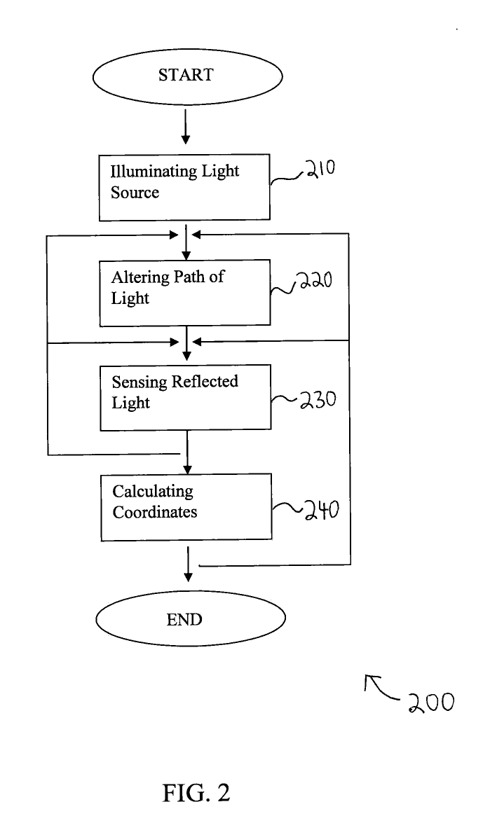

FIG. 2 depicts a flow diagram of an exemplary method 200 for determining three-dimensional (3D) absolute coordinates. Consistent with some embodiments, method 200 may include a series of steps for performing the functions of the three-dimensional (3D) absolute coordinate sensing system 100 of FIG. 1. As an example, a light source 120 comprising a laser diode is illuminated in step 210. In step 220, the path of light from light source 120 is altered by path altering unit 130. In one embodiment, step 220 may include continuously and automatically adjusting MEMS mirrors according to system specifications. Next, sensing unit 140 senses the light reflected from objects in step 230. In this step, data from the sensing unit 140 are sent to processor 110. Finally, based in part on the data from the sensing unit 140, three-dimensional (3D) absolute coordinates are calculated by the processor 110.

Steps 220, 230, and 240 may be repeated according to the various applications or specifications that may vary based on the applications of the method or system. For example, these steps may be repeated for the purpose of provide enhanced or continuous tracking of an object, or to calculate a more accurate absolute coordinates of tracked objects. As shown in FIG. 2, steps 220, 230, and 240 may be repeated after step 230 and/or step 240 is performed.

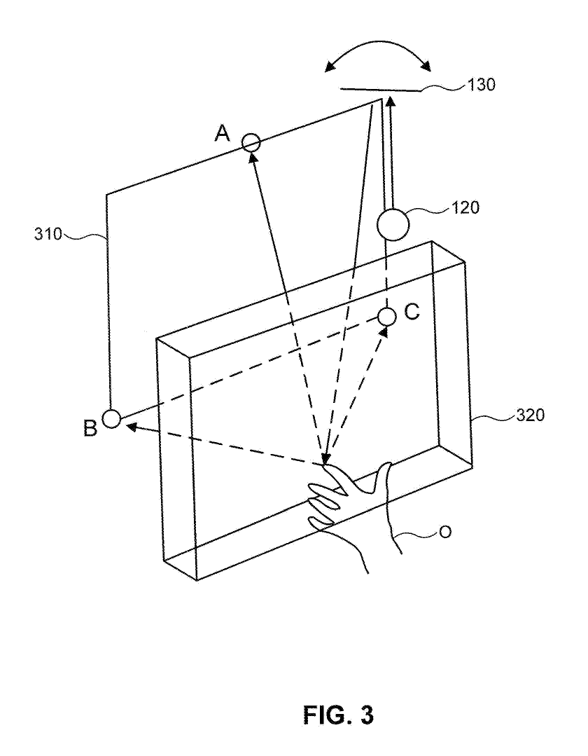

FIG. 3 illustrates an exemplary embodiment of a three-dimensional (3D) absolute coordinate sensing system including placement of certain components.

Referring to FIG. 3, sensors A, B, and C are placed on the periphery of display element 310. In some embodiments, more than three sensors may be used to more accurately locate the absolute coordinates of an object O, e.g. fingertip, palm, head, etc. On the periphery of display element 310 is also a light source 120 and path altering unit 130. Together, light source 120 and path altering unit 130 may create, define, and/or control a scanning region 320. The scanning region 320 may be created by the central processing unit 110 adjusting the MEMS mirrors of path altering unit 130 to change the path of the light source 120. In an exemplary embodiment, when object O moves into scanning region 320, sensing system 100 may track, create a three-dimensional (3D) image, or provide an absolute coordinate of the object.

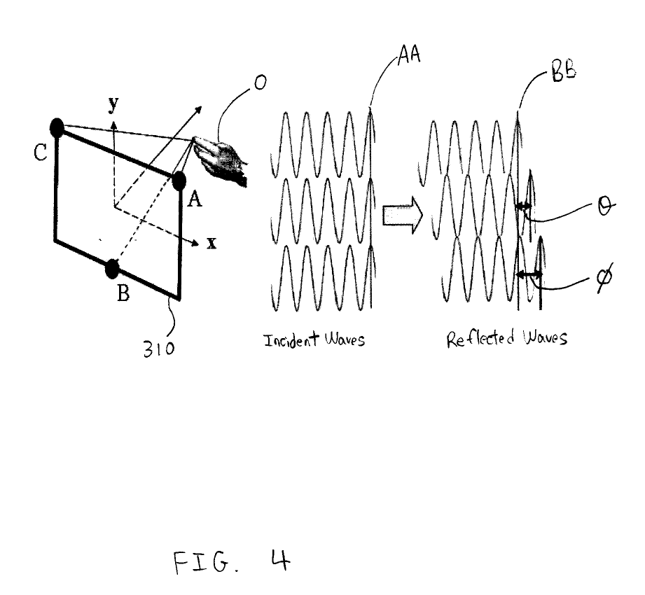

FIG. 4 illustrates an exemplary embodiment of reflected and diffused light corresponding to individual sensors. As shown in FIG. 4 and similar to FIG. 3, sensors A, B, and C are placed on the periphery of display element 310. When light, from light source 120 via path altering unit 130, is reflected back from object O, the diffused light travels back to the display and is detected by sensors A, B, and C. As the distances from each of the sensors A, B, and C to the object O may be different, each of the sensors may detect the diffused light at a different point on the reflected wave. As shown by the incident waves in FIG. 4, line AA represents the moment the light from light source 120 is reflected at object O. Line BB represents the moment sensors A, B, and C detect the reflected light. Further, assuming the topmost reflected wave detected at one of the sensors is the reference wave, a phase difference may be calculated between the reference wave and the waves detected at the other two sensors. In FIG. 4, the topmost reflected wave is deemed to be the reference wave with a detection point at a peak of the wave. The length from line BB to the next peak for the bottom two reflected waves, defined by θ and φ respectively, represent the phase differences between the wave detected at the reference sensor and each of the two waves detected at the remaining two sensors. As phase difference corresponds with a distance, the difference in distance between each of the sensors A, B, and C, and the object under analysis may be determined. Thus, if one distance is known, the other distances may be derived. In alternative embodiments, the distances between each of the sensors A, B, and C, and the object under analysis may also be separately determined based on a number of different methods.

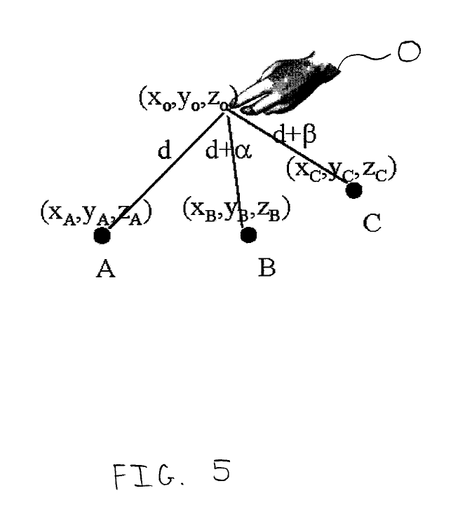

FIG. 5 depicts an exemplary embodiment of an object's three-dimensional (3D) absolute coordinates in relation to the coordinates of various individual sensors. As shown in FIG. 5, the fingertip of a user's hand O is the object under analysis. At any point in space, the fingertip has absolute coordinates of (xₒ,yₒ,zₒ). Further, sensors A, B, and C, which are provided on the periphery of a display (not shown), are provided with fixed three-dimensional (3D) absolute coordinates. Sensor A has absolute coordinates of (x_{A}, y_{A}, z_{A}); sensor B has absolute coordinates of (x_{B}, y_{B}, z_{B}); and sensor C has absolute coordinates of (x_{C}, y_{C}, z_{C}). In some embodiments, more than three sensors are present, each having their individual fixed absolute coordinates. In some embodiments, a plurality of sensors, and thus their absolute coordinates, are adjustable and controlled by central processing unit 110 as shown in FIG. 1.

Also shown in FIG. 5 are the distances between the fingertip and the sensors A, B, and C. For example, the distance between sensor A and the finger tip is labeled as d. As described above with reference to FIG. 4, a distance may be measured by various methods. Once d is determined, and the difference in distances α and β are derived from the phase differences between the wave detected at the reference sensor (e.g. sensor A) and each of the two waves detected at the remaining two sensors (e.g. sensors B and C), the absolute coordinates (xₒ,yₒ,zₒ) of the fingertip may be solved by the following system of three equations:

\sqrt{(xₒ−x_{A})²+(yₒ−y_{A})²+(zₒ−z)²}=d Equation 1

\sqrt{(xₒ−x_{B})²+(yₒ−y_{B})²+(zₒ−z_{B})²}=d+α Equation 2

\sqrt{(xₒ−x_{C})²+(yₒ−y_{C})²+(zₒ−z_{C})²}=d+β Equation 3

Equation 1 represents the spatial distance formula from sensor A to the fingertip; Equation 2 represents the spatial distance formula from sensor A to the fingertip; and Equation 3 represents the spatial distance formula from sensor A to the fingertip.

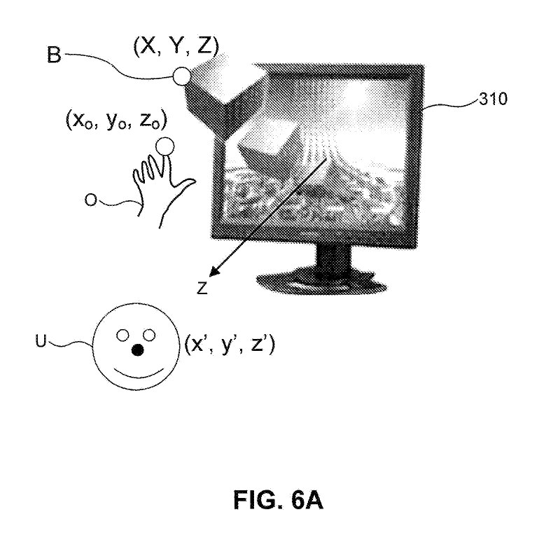

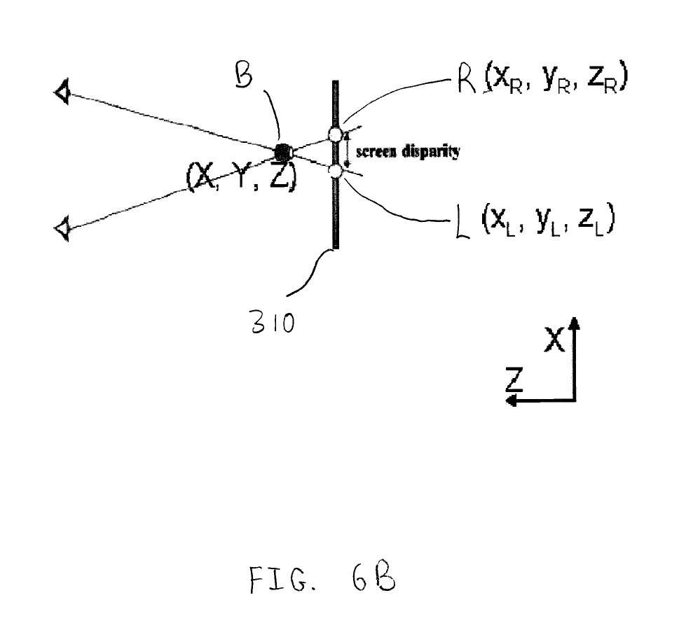

FIGS. 6A and 6B depict an exemplary embodiment of an interactive three-dimensional (3D) absolute coordinate sensing system including coordinates of a perceived image.

As shown in FIG. 6A, a user U with a coordinate of (x′, y′, z′) observes a three-dimensional (3D) display 310 along the Z-axis. The display 310 is capable of producing a 3D image, such as an icon or a button with a point B, that is perceived by the user to be in front of the display 310. Point B may include a perceived coordinate of (X, Y, Z) as determined by the display. When the user engages the image with his/her fingertip, the display, equipped with a three-dimensional (3D) absolute coordinate sensing system 100, may be able to track the absolute coordinates (xₒ,yₒ,zₒ) of the fingertip. The system may also be able to detect the instance that the user's fingertip “contacts” the perceived point. That is, the point where the fingertip coordinate of (xₒ,yₒ,zₒ) and the image's perceived coordinate of (X, Y, Z) are substantially the same. The sensing system's central processing unit 110, or an associated processor/controller, may be configured to process this “contact” as a distinct human-machine interaction. For example, the “contact” may be interpreted as a click or selection of the icon or button Y. The “contact” may also be interpreted as docketing the image to the fingertip so that the image may be dragged across and manipulated on the display.

FIG. 6B depicts the creation of the perceived coordinate of a 3D image as discussed with respect to FIG. 6A. As shown in FIG. 6B, image element R with a fixed coordinate of (x_{R}, y_{R}, z_{R}) is a pixel element on display 310 for creating an image for the user's right eye. Similarly, image element L with a fixed coordinate of (z_{L}, y_{L}, z_{L}) is a pixel element on the display 310 for creating an image for the user's left eye. Together, the image elements R and L produce a 3D image extending from the screen plane in the Z-axis direction with a perceived point B having a coordinate of (X, Y, Z). In some embodiments, coordinate X of point B (X, Y, Z) is calculated by determining the average of the x-coordinates values (x_{R} and x_{L}) of the image elements R and L; coordinate Y of point B is the same as the y-coordinates (y_{R} and y_{L}) of the image elements R and L; and coordinate Z of point B is calculated as a function of x-coordinates values (x_{R} and x_{L}) of the image elements R and L. As such, equipped with the above-disclosed three-dimensional (3D) absolute coordinate sensing system and a 3D image's perceived coordinate of (X, Y, Z), it is possible to determine the interaction between a user and a 3D image system.

It will be apparent to those skilled in the art that various modifications and variations can be made to the disclosed methods and materials. For example, the three-dimensional (3D) absolute coordinate sensing system may be modified and used in various settings, including but not limited to security screening systems, motion tracking systems, medical imaging systems, entertainment and gaming systems, imaging creation systems, etc. Further, the three-dimensional (3D) display as disclosed above may be other types of displays such as volumetric displays or holographic displays.

In the foregoing Description of the Embodiments, various features are grouped together in a single embodiment for purposes of streamlining the disclosure. The disclosure is not to be interpreted as reflecting an intention that the claimed subject matter requires more features than are expressly recited in each claim.

Moreover, it will be apparent to those skilled in the art from consideration of the specification and practice of the present disclosure that various modifications and variations can be made to the disclosed systems and methods without departing from the scope of the disclosed embodiments, as claimed. For example, one or more steps of a method and/or one or more components of an apparatus or a device may be omitted, changed, or substituted without departing from the scope of the disclosed embodiments. Thus, it is intended that the specification and examples be considered as exemplary only, with a scope of the present disclosure being indicated by the following claims and their equivalents.

What is claimed is:

1. A non-contact coordinate sensing system for identifying three-dimensional coordinates of an object, the system comprising:
at least one light source configured to illuminate light to the object and to be controlled for object detection;
a first detecting device configured to detect light reflected from the object to a first location, the first location being identified by a first set of three-dimensional coordinates;
a second detecting device configured to detect light reflected from the object to a second location, the second location being identified by a second set of a three-dimensional coordinates;
a third detecting device configured to detect light reflected from the object to a third location, the third location being identified by a third set of a three-dimensional coordinates; and
a control circuit coupled to the at least one light source and the first, second, and third detecting devices and configured to determine the three-dimensional coordinates of the object at least based on the phase differences between the reflected light detected at one of the first, second, and third locations and the reflected light detected at remaining locations.

2. The sensing system of claim 1 further comprising a path altering unit coupled to the light source and the control circuit for controlling the object detection, the path altering unit configured to redirect the light from the light source to the object.

3. The sensing system of claim 2, wherein the path altering unit comprises at least one MEMs mirror.

4. The sensing system of claim 1, wherein the control circuit is further configured to determine a distance between one of the light detecting devices and the object.

5. The sensing system of claim 2, wherein the control circuit is further configured to control the path altering unit to adjust the path of the light to the object.

6. The sensing system of claim 1, wherein the control circuit solves a system of distance equations using at least the first, second, and third sets of three-dimensional coordinates.

7. The sensing system of claim 1, wherein the at least one light source is a laser diode.

8. The sensing system of claim 1, wherein the at least one light source comprises at least one illumination element configured to operate at different frequencies.

9. The sensing system of claim 1, wherein the control circuit is further configured to create an three-dimensional image of the object based on the determined three-dimensional coordinates of the object.

10. An interactive three-dimensional (3D) display system comprising:
at least one light source for illuminating light to an object and to be controlled for object detection;
a first light detecting device for detecting reflected light from the object to a first location, the first location being identified by a first set of three-dimensional coordinates;
a second light detecting device for detecting reflected light from the object to a second location, the second location being identified by a second set of three-dimensional coordinates;
a third light detecting device for detecting reflected light from the object to a second location, the second location being identified by a third set of three-dimensional coordinates; and
a control circuit coupled the at least one light source and the first, second, and third light detecting devices and configured to determine three dimensional coordinates of the object, wherein the control circuit is also configured to produce 3D images with three-dimensional coordinates and further configured to determine an interaction between the object and the 3D images based on the three-dimensional coordinates of the object and the three-dimensional coordinates of the 3D images.

11. The display of claim 10, wherein the three-dimensional coordinates of the object are determined by measuring phase differences between light reflected by the object detected at one of the first, second, and third locations, and light reflected by the object detected at remaining locations.

12. A method of identifying three-dimensional (3D) coordinates of an object, the method comprising:
illuminating light to the object;
sensing light reflected by the object by at least three sensing devices, wherein each of the light sensing devices is at a different location, each of the locations is identified by a set of three-dimensional coordinates;
calculating, by a processor, the three-dimensional coordinates of the object based on the phase differences between the reflected light detected at one of the locations and the reflected light detected at the remaining locations.

13. The method of claim 12, further comprising redirecting the path of the light to the object.

14. The method of claim 12, further comprising controlling at least a frequency of the light.

15. The method of claim 13, further comprising adjusting the redirected path of the light to the object.

16. The method of claim 12, further comprising adjusting at least one of the locations of the three sensing devices.

17. The method of claim 12, further comprising repeating the sensing and calculating to track the location of the object or to create a three-dimensional image of the object.

18. The method of claim 14, further comprising repeating the redirecting, sensing, and calculating to track the location of the object or to create a three-dimensional image of the object.

19. The method of claim 12, wherein the calculating by the processor further comprises determining a distance between one of the light detecting devices and the object.

20. The method of claim 12, wherein the calculating by the processor further comprises solving a set of distance equations using the coordinates of the at least three light sensing devices.
